(19) United States
(12) Patent Application Publication
(10) Pub. No.: US 2012/0055154 A1
(43) Pub. Date: Mar. 8, 2012

(54) TURBOCHARGER

(75) Inventor: Stefan Ebert, Kindenheim (DE)

(73) Assignee: BorgWarner Inc., Auburn Hills, MI (US)

(21) Appl. No.: 13/320,282

(22) PCT Filed: May 11, 2010
(86) PCT No.: PCT/US2010/034308

§ 371 Date: Nov. 14, 2011

(30) Foreign Application Priority Data
May 18, 2009 (DE) 102009021737.1

(51) Int. Cl. F02C 6/12

(52) U.S. Cl. 60/602

(57) ABSTRACT

The invention relates to a turbocharger (1) in which, for damping the wastegate flap/wastegate lever system, an axially acting spring element is provided in order to reduce wear. The turbocharger (1) comprises a compressor (2) and a turbine (3) which has a turbine housing (4) and a wastegate device (6) with a regulating flap (7). The flap plate (7′) of the regulating flap (7) is arranged, via a lever (5), on a regulating flap shaft (9) which is guided in the turbine housing (4) by means of a bush (8). Here, the flap plate (7′) is preloaded against the lever (5) by means of a spring element (10).

The invention relates to a turbocharger according to the preamble of claim 1.

A generic turbocharger is known from EP 1 256 703 B1.

In supercharged internal combustion engines which use an exhaust-gas turbocharger, the latter is often provided with a so-called wastegate arrangement. In known turbochargers, the wastegate is integrated in the turbine housing and is composed of a rotatably mounted shaft with a lever to which a flap is fastened movably with play, and a flap seat against which the flap bears. Such arrangements often result in problems because wear can occur at the wastegate flap/wastegate seat contact point as a result of vibrations of the flap incited by the exhaust-gas flow and/or the wastegate actuation.

In the case of a non-damped system, in the present prior art, the component tolerances, primarily when the flap is slightly open, in particular in applications which require large flap dimensions or which operate without external damping of the wastegate actuation, cause wear to occur as a result of rattling, clattering or dynamic impacting of the flap plate against the wastegate seat as a result of the play which is present.

It is therefore an object of the present invention to provide a turbocharger of the type specified in the preamble of claim 1, which makes it possible to reduce or prevent said wear.

Said object is achieved by means of the features of claim 1.

Subclaims 2 to 6 relate to advantageous refinements of the invention.

In the design of the turbocharger according to the invention, therefore, a spring element is arranged in connection with the wastegate flap/wastegate lever system in order to dampen the system against wear by eliminating the play. Here, planar or complete contact of the flap plate on the seat is additionally made possible as a result of the deformation of the spring element.

Here, it is possible for the spring element to be designed as a plate spring or for the spring element to be produced as a planar part whose radially inner region is elastically deformable relative to the outer region. As well as reducing wear, the arrangement of a spring element also provides production advantages and therefore minimizes costs, primarily as a result of the elimination of the play.

Further details, advantages and features of the present invention will emerge from the following description of exemplary embodiments on the basis of the appended drawing, in which:

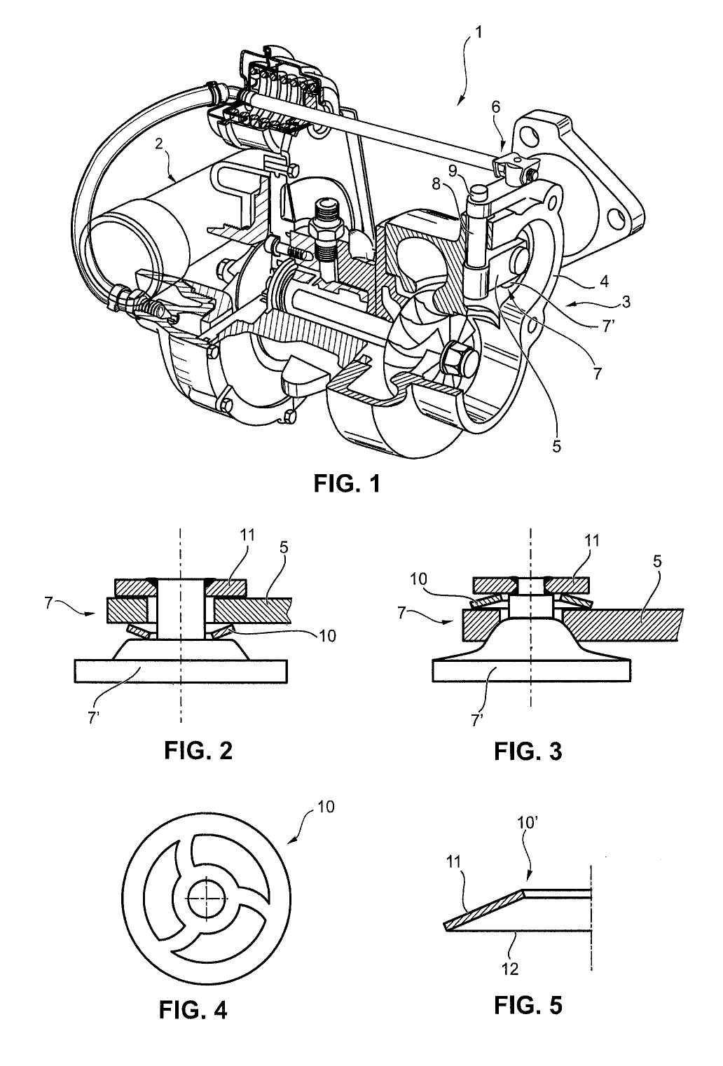

FIG. 1 shows a perspective, cut-away illustration of a turbocharger;

FIG. 2 shows a sectional view of an embodiment in which the spring element is arranged between the lever and the flap plate;

FIG. 3 shows a sectional illustration of a second embodiment, with the spring element being arranged between the lever and a disk;

FIG. 4 shows a plan view of a planar spring element; and

FIG. 5 shows a side view of a plate spring.

FIG. 1 illustrates a turbocharger 1 which comprises a compressor 2 and a turbine 3. The turbine 3 comprises a turbine housing 4 and a wastegate device 6 which has a regulating flap 7. The regulating flap 7 comprises a flap plate 7′ which is arranged, via a lever 5, on a regulating flap shaft 9 which is guided in the turbine housing 4 by means of a bush 8.

As can be seen from FIG. 2, the flap plate 7′ is preloaded against the lever 5 by means of a spring element 10. In a first embodiment, the spring element 10 is arranged between the flap plate 7′ and the lever 5.

In FIG. 3, in a second embodiment, the spring element 10 is arranged between the lever 5 and a disk 11 which is connected to the flap plate 7′.

In both design variants, the connection between the disk 11 and the flap plate 7′ may be a welded or riveted connection without play. According to the invention, the spring element 10 may have different spring shapes. As illustrated in FIG. 4, the spring element may be designed as a plate spring 10.

In FIG. 5, as an alternative embodiment, the spring element 10′ is composed of two rigid spring element regions 11, 12 which are connected by means of elastic webs 13.

To complement the written disclosure given above, reference is explicitly made to the diagrammatic illustration in FIGS. 1 to 5 of the invention.

### LIST OF REFERENCE NUMERALS

1 Turbocharger
2 Compressor
3 Turbine
4 Turbine housing
5 Lever
6 Wastegate device
7 Regulating flap
7′ Flap plate
8 Bush
9 Regulating flap shaft
10, 10′ Plate spring or planar spring element
11, 12 Planar spring element regions
13 Elastic connecting webs

1. A turbocharger (1)
having a compressor (2),
having a turbine (3),
having a turbine housing (4),
having a wastegate device (6) which has a regulating flap (7) whose flap plate (7′) is arranged, via a lever (5), on a regulating flap shaft (9) which is guided in the turbine housing (4) by means of a bush (8),
wherein
the flap plate (7′) is preloaded against the lever (5) by means of a spring element (10).

2. The turbocharger (1) as claimed in claim 1, wherein the spring element (10) is arranged between the flap plate (7′) and the lever (5).

3. The turbocharger (1) as claimed in claim 1, wherein the spring element (10) is arranged between the lever (5) and a disk (11) which is connected to the flap plate (7′).

4. The turbocharger (1) as claimed in claim 1, wherein the disk (11) is connected to the flap plate (7′) without play by means of riveting or welding.

5. The turbocharger (1) as claimed in claim 1, wherein the spring element is designed as a plate spring (10).

6. The turbocharger (1) as claimed in claim 1, wherein the spring element (10′) is composed of two rigid spring element regions (11, 12) which are connected by means of elastic connecting webs (13).
